(19) United States
(12) Patent Application Publication
(10) Pub. No.: US 2007/0064606 A1
(43) Pub. Date: Mar. 22, 2007

(54) Multiple network system and service providing method

(76) Inventors: Rae-Jin Uh, Seoul (KR); Sung-Guk Na, Suwon-si (KR)

Correspondence Address: ROBERT E. BUSHNELL, 1522 K STREET NW, SUITE 300, WASHINGTON, DC, 20005-1202, US

(21) Appl. No.: 11/495,516

(22) Filed: Jul. 31, 2006

(30) Foreign Application Priority Data
Sep. 7, 2005 (KR) 10-2005-0083283

(51) Int. Cl. H04L 12/26

(52) U.S. Cl. 370/230

(57) ABSTRACT

A multiple network system and service providing method, wherein the multiple network system comprises a service server for providing at least one service; at least one terminal for accessing at least one network; and a manager server for recognizing a bandwidth of each service provided by the service server, a permissible bandwidth of each network, and each terminal accessing each network, and, for each service, blocking access of each terminal requesting the service to each network having a smaller permissible bandwidth than the service.

### CLAIM OF PRIORITY

This application makes reference to, incorporates the same herein, and claims all benefits accruing under 35 U.S.C. §119 from an application for APPARATUS AND METHOD OF SERVICE PROVIDING IN MULTITUDE NETWORK SYSTEM filed in the Korean Intellectual Property Office on the 7 of Sep. 2005 and there duly assigned Serial No. 10-2005-0083283.

### BACKGROUND OF THE INVENTION

1 Field of the Invention

The present invention relates to a multiple network system and a method of providing service in the multiple network system.

2 Description of the Related Art

The ongoing development of network technology has led to the introduction of various networks such as a local area network (LAN), a wireless LAN (WLAN), an ultra wideband network (UWB), and a Zigbee network.

Recent years have seen the emergence of a trend of one terminal accessing a plurality of such networks in order to satisfy a customer's various needs and improve quality of service provision.

In a home network system having multiple network resources, a terminal provides a service through one network resource.

However, when the network accessed by the terminal has insufficient resources, the quality of service provision may be lowered or the service may be interrupted.

For example, a terminal of a home network system may have a multiple interface, and a plurality of terminals may access a wireless LAN to be provided with an Internet service. Here, a streaming service cannot be provided to a certain terminal requesting that service if it requires more bandwidth than is available in the wireless LAN, and if the streaming service is provided, other terminals accessing the wireless LAN are deprived of sufficient bandwidth resources.

### SUMMARY OF THE INVENTION

It is an objective of the present invention to provide a multiple network system in which network overload is prevented to thereby improve quality of service provision.

It is another objective of the present invention to provide a service providing method in a multiple network system in which network overload is prevented to thereby improve quality of service provision.

According to an aspect of the present invention, there is provided a multiple network system comprising: a service server for providing at least one service; at least one terminal for accessing at least one network; and a manager server for recognizing a bandwidth of each service provided by the service server, a permissible bandwidth of each network, and each terminal accessing each network, and, for each service, blocking access of each terminal requesting the service to each network having a smaller permissible bandwidth than the service.

The multiple network system may further comprise at least one blocking filter for blocking access of the network or terminal according to address information contained in access blocking information received from the manager server.

The manager server may comprise an information recognizing unit for recognizing bandwidth information of each service, permissible bandwidth information and address. information of each network, and address information of each terminal according to network; and a network setting unit for setting in the blocking filter, for each service, address information of a network having a smaller permissible bandwidth than the service and address information of a terminal accessing the network.

The multiple network system may further comprise at least one monitoring unit for monitoring resource occupancy of each network and transmitting to the manager server identification information of a corresponding network and address information of a terminal which accesses the corresponding network when the resource occupancy exceeds a previously set reference occupancy.

Each terminal may include at least one interface for accessing each network; and an interface processor for transmitting the service request message to the manager server through the at least one interface and accessing the service server through the interface interworked with a network corresponding to the network identification information contained in the service response message.

According to another aspect of the present invention, there is provided a multiple network system accessed by at least one terminal, comprising: a manager server for identifying a terminal which is enabled to access another network among terminals accessing an access network and transmitting a network change request message to the terminal when a resource occupancy of each network exceeds a reference resource occupancy, wherein the terminal changes the access network to another network accessible thereby when the network change request message is received from the manager server.

According to still another aspect of the present invention, there is provided a multiple network system including at least one terminal and a service server, comprising: a manager server for recognizing bandwidth information of each service provided by the service server, permissible bandwidth information of each network, or identification information of a network accessible by each terminal, and transmitting to a corresponding terminal identification information of a network having a larger bandwidth than a service requested by the terminal, among the networks accessible by the terminal, when the bandwidth of the service is larger than a permissible bandwidth of the network accessed by the terminal, wherein the service requested by the terminal is selected by a user and requested to the manager server, and the terminal accesses the service server through a network corresponding to the identification information.

According to yet another aspect of the present invention, there is provided a service providing method in a multiple network system accessed by at least one terminal, comprising: recognizing bandwidth information of at least one service, permissible bandwidth information of each network, address information of each network, or address information of each terminal accessing each network; receiving a service request from each terminal; and blocking access to the service when a bandwidth of the service requested by the terminal is larger than the permissible bandwidth of the network currently accessed by the terminal.

The service providing method in the multiple network system may further comprise recognizing identification information of each network; recognizing address information of a terminal accessing an access network when a resource occupancy of the access network exceeds a previously set reference occupancy; identifying a terminal capable of accessing another network and transmitting identification information of the other network to the identified terminal; and changing the access network accessed by the terminal to a network corresponding to the transmitted network identification information; at each terminal, requesting a service type selected by a user; identifying a network accessible by the terminal when a permissible bandwidth of the network currently accessed by the terminal is smaller than a bandwidth of the requested service; and transmitting identification information of the identified network to the terminal and changing the access network accessed by the terminal to identified network, thereby enabling the service to be used.

According to yet another aspect of the present invention, there is provided a service providing method in a multiple network system accessed by at least one terminal, comprising: recognizing identification information of each network and address information of each terminal capable of accessing each network; recognizing address information of a terminal accessing a network when a resource occupancy of the network exceeds a previously set reference occupancy; identifying a terminal capable of accessing another network and transmitting identification information of the other network to the identified terminal; and changing the network accessed by the terminal to the other network corresponding to the identification information.

According to yet another aspect of the present invention, there is provided a service providing method in a multiple network system accessed by at least one terminal, comprising: recognizing bandwidth information of at least one service, permissible bandwidth information of each network, or identification information accessible by each terminal; requesting, at each terminal, a service type selected by a user; identifying a network accessible by a terminal when a permissible bandwidth of a network currently accessed by the terminal is smaller than a bandwidth of the requested service; and transmitting identification information of the identified network to the terminal so that the terminal is provided with the service through the identified network.

The service providing method in the multiple network system may further comprise transmitting identification information of each identified network to the terminal when a plurality of networks are identified; using a service through a network having relatively large permissible bandwidth information among the identified networks; managing a resource occupancy of each network; and transmitting identification information of an identified network having a relatively small resource occupancy to the corresponding terminal when a plurality of networks are identified.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram of a multiple network system according to an exemplary embodiment of the present invention;

FIG. 2 is a block diagram of a manager server according to an exemplary embodiment of the present invention;

FIG. 3 is a block diagram of a terminal according to an exemplary embodiment of the present invention;

FIG. 4 is a flowchart illustrating a service providing procedure in a multiple network system according to an exemplary embodiment of the present invention;

FIG. 5 is a flowchart illustrating a resource managing method in a multiple network system according to an exemplary embodiment of the present invention;

FIG. 6 is a flowchart illustrating a network managing method in a multiple network system according to an exemplary embodiment of the present invention; and

FIG. 7 is a flowchart illustrating a service providing method in a multiple network system according to an exemplary embodiment of the present invention.

### DETAILED DESCRIPTION OF EXEMPLARY EMBODIMENTS

The present invention will now be described more fully hereinafter with reference to the accompanying drawings, in which exemplary embodiments of the invention are shown.

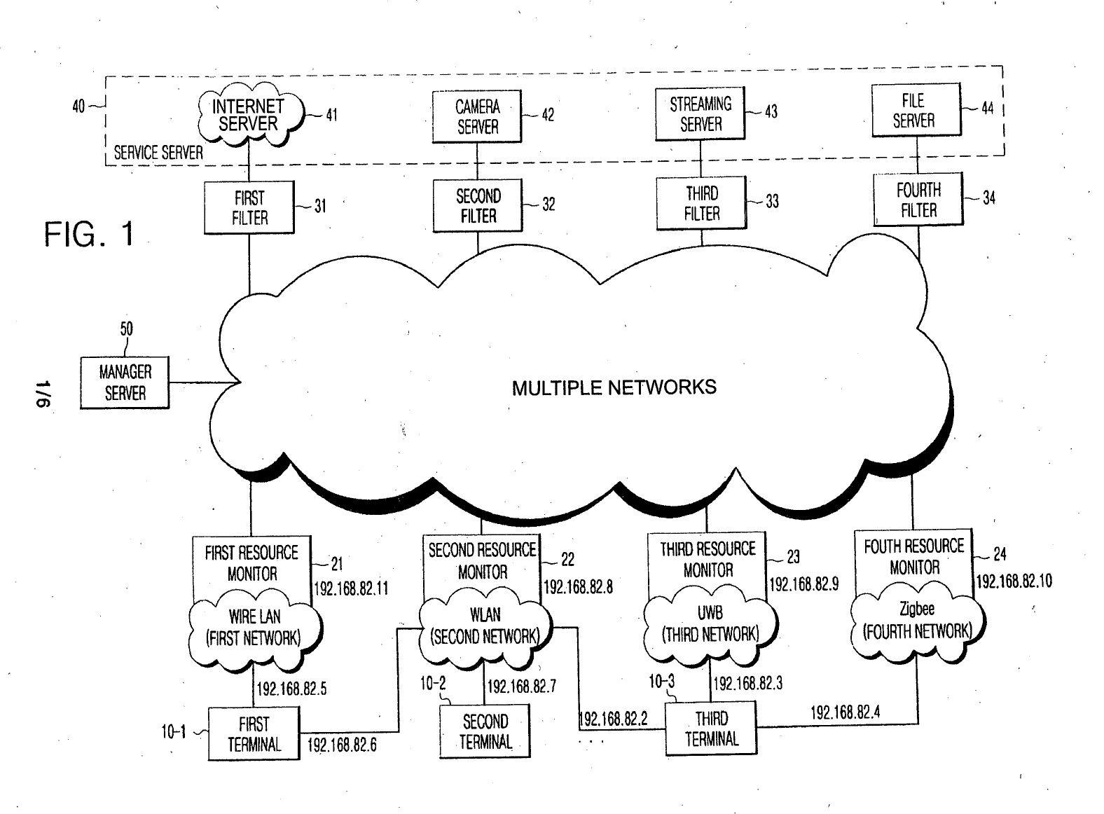

FIG. 1 is a block diagram of a multiple network system according to an exemplary embodiment of the present invention.

Referring to FIG. 1, the multiple network system of the present invention includes a service server 40, a plurality of filters 31-34 (also referred to in plurality as filters 3n), a plurality of resource monitors 21-24 (also referred to in plurality as monitors 2n) which monitor the resource status of a plurality of networks, a manager server 50, and a plurality of terminals 10-1, 10-2 and 10-3 (also referred to in plurality as terminal 10).

The service server 40 includes an Internet server 41 which provides an Internet service, a camera server 42 which provides a camera service, a streaming server 43 which provides a moving picture streaming service, and a file server 44 which provides a file service.

The Internet server 41 provides an Internet service with a bandwidth depending on the network status and capability of the terminals 10-1, 10-2 and 10-3. That is, the Internet server 41 provides an Internet service without a limitation on a minimum bandwidth.

The camera server 42 provides the terminals 10-1, 10-2 and 10-3 with a cameral service, i.e., image data with a minimum bandwidth of 5 Mbps.

The streaming server 43 seamlessly provides the terminals 10-1, 10-2 and 10-3 with moving picture data with a minimum bandwidth of 19 Mbps.

The file server 44 provides the terminals 10-1, 10-2 and 10-3 with file data with a minimum bandwidth of 200 Kbps.

The filters 3n block access of the terminals 10-1, 10-2 and 10-3 or network having address information corresponding to an address contained a blocking message received from the manager server 50.

The manager server 50 registers address information of each of terminals 10-1, 10-2 and 10-3 allocated from each network through a negotiation procedure with each of terminals 10-1, 10-2 and 10-3.

The manager server 50 produces a plurality of first tables which contain network identification information, IP address information of each of terminals 10-1, 10-2 and 10-3 according to the network identification information, and network status information (bandwidth, power, service distance, etc.).

The manager server 50 stores a second table which contains minimum rate information of a service provided by each server of the service server 40, and a third table which contains status information and IP address information of each network.

The manager server 50 transmits the blocking message to the filters 3n according to the address information of each of terminals 10-1, 10-2 and 10-3 of the first table and the network status information of each server of the third table.

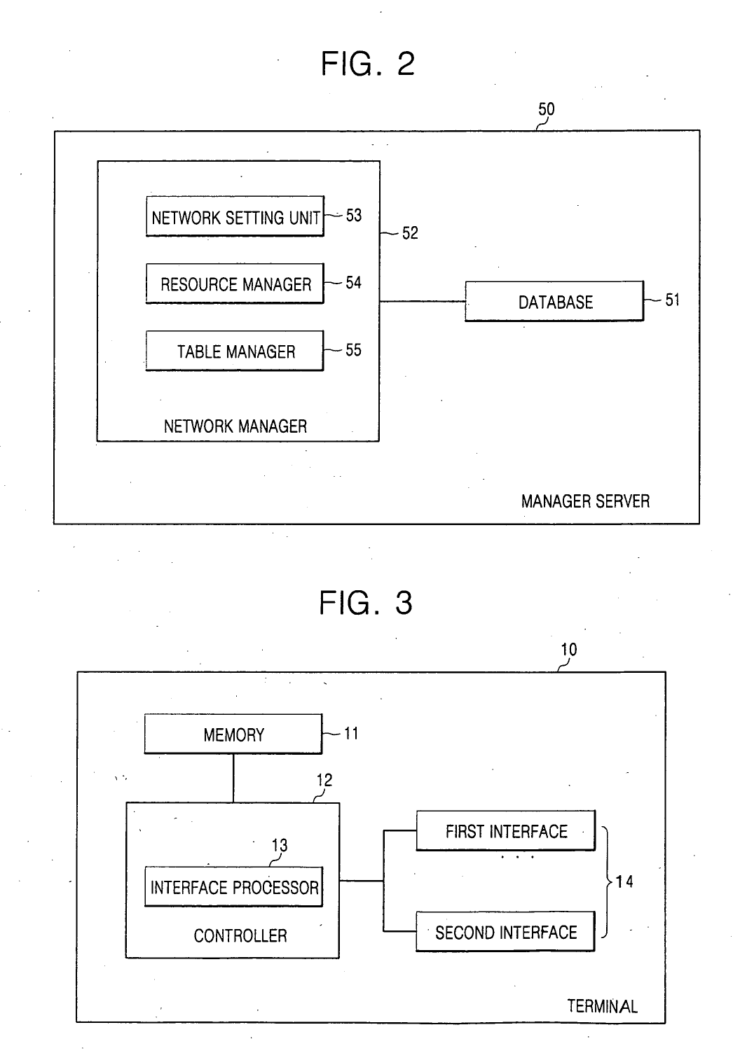

FIG. 2 is a block diagram of a manager server according to an exemplary embodiment of the present invention.

Referring to FIG. 2, the manager server 50 includes a database 51 and a network manager 52. The network manager 52 includes a network setting unit 53, a resource manager 54, and a table manager 55.

The network manager 52 stores the second table which contains the minimum rate information for each service which the service server 40 provides to each of terminals 10-1, 10-2 and 10-3 through a multiple network in the database 51.

Table 1 shows the second table managed by the network manager 52:

TABLE 1

| Service Type | Minimum bandwidth |
|---|---|
| File service | 200 Kbps |
| Streaming service | 19 Mbps |
| Internet service | no limit |
| Camera service | 5 Mbps |
| . . . | . . . |

As can be seen in Table 1, the minimum bandwidth depends on a service type which the service server 40 provides to each of terminals 10-1, 10-2 and 10-3.

The network manager 52 stores the third table which contains the IP address information, identification information, and minimum bandwidth information of each network in the database 51. Table 2 shows the third table managed by the network manager 52:

TABLE 2

| | Second | Third | Fourth | First |
|---|---|---|---|---|
| | network | network | network | Network |
| | (WLAN) | (UWB) | (Zigbee) | (wire LAN) |
| IP address | 192.168.82.8 | 192.168.82.9 | 192.168.82.10 | 192.168.82.11 |
| Bandwidth | 5 Mbps | 100 Mbps | 250 Kbps | 100 Mbps |
| Power | 1 W | 200 mW | 50 mW | — |
| Service | 50M | 20M | 50M | wire |
| distance | | | | |

As can be seen in Table 2, the network manager 52 manages the IP address information of each network and the network status information, i.e., minimum bandwidth information, of each network.

The manager server 50 receives the status information of each network connected from an operator and stores it in the database 51, and produces the third table according to the address information of each network connected and the status information of a corresponding network and stores it in the database 51.

The network manager 52 registers the address information of each of terminals 10-1, 10-2 and 10-3 allocated from each network through the negotiation procedure with each of terminals 10-1, 10-2 and 10-3.

The network manager 52 manages the plurality of first tables which contain the identification information of networks accessible by each of terminals 10-1, 10-2 and 10-3, the IP address information allocated from each network, and the network status information (bandwidth, power, service distance, etc.). Tables 3a to 3c show the first tables managed by the network manager 52.

TABLE 3a

| First terminal | First network | Third network |
|---|---|---|
| IP address | 192.168.82.5 | 192.168.82.6 |
| Bandwidth | 100 Mbps | 5 Mbps |
| Power | — | 1 W |
| Service distance | wire | 50M |

TABLE 3b

| Second terminal | First network |
|---|---|
| IP address | 192.168.82.8 |
| Bandwidth | 5 Mbps |
| Power | 1 W |
| Service distance | 50M |

TABLE 3c

| Third Terminal | Second network | Third network | Fourth network |
|---|---|---|---|
| IP address | 192.168.82.2 | 192.168.82.3 | 192.168.82.4 |
| Bandwidth | 5 Mbps | 100 Mbps | 250 Kbps |
| Power | 1 W | 200 mW | 50 mW |
| Service distance | 50M | 20M | 50M |

As can be seen in Tables 3a to 3c, the network manager 52 manages each first table which contains the IP address information allocated from each network accessible by each of terminals 10-1, 10-2 and 10-3 and the identification information of each network.

The network manager 52 transmits a first table to a corresponding one of terminals 10-1, 10-2 and 10-3 through a negotiation procedure.

The table manager 55 of the network manager 52 manages the second table according to the bandwidth information of each server, the third table according to the bandwidth information and the IP address information of each network, and the plurality of first tables according to the network information of the network accessed by each of terminals 10-1, 10-2 and 10-3 through the negotiation procedure and the IP address information allocated from the corresponding network.

The table manager 55 produces a first table for a new terminal and stores it in the database 51.

The network setting unit 53 of the network manager 52 transmits the blocking message to each filter 3n interworked with each server by using the minimum bandwidth information of the service provided by each server of the service server 40, the bandwidth information of each network, and the IP address information of the terminals 10-1, 10-2 and 10-3 which has access to each network.

For example, the network setting unit 53 transmits the blocking message which does not contain the IP address information to the first and fourth filters 31 and 34 respectively interworked with the Internet server 41 and the file server 44. That is, the network setting unit 53 transmits the blocking message which does not contain the IP address information since there is no service type which has a smaller bandwidth than the minimum bandwidth with which the Internet server 41 and the file server 44 process data and the bandwidth of each network is greater than the bandwidth of the Internet server 41 and the file server 44.

The network setting unit 53 transmits the blocking message containing the IP address information (192.168.82.10) of the fourth network, i.e., the Zigbee network, which has a smaller bandwidth than 5 Mbps, and the IP address information (192.168.82.4) of the third terminal 10-3 which accesses the fourth network since the bandwidth of the camera server 42 is 5 Mbps, to the second filter 32.

Consequently, the second filter 32 blocks 192.168.82.10 and 192.168.82.4 which are the IP address information contained in the blocking message. That is, the second filter 32 blocks access of the IP address information contained in the blocking message.

The network setting unit 53 transmits to the third filter 33 the blocking message containing the IP address information (192.168.82.8) of the second network which has a smaller bandwidth than 19 Mbps and the IP address information (192.168.82.2, 192.168.82.6, and 192.168.82.7) of the terminals 10-1, 10-2 and 10-3. which access the second network, the IP address information (192.168.82.10) of the fourth network which has a smaller bandwidth than 19 Mbps, and the IP address information (192.168.82.4) of the terminal 10-3 which accesses the fourth network since the bandwidth of the streaming server 43 is 19 Mbps.

Thus, the third filter 33 blocks access of the IP address information contained in the blocking message.

Accordingly, each filter 3n blocks access of a network or terminal which has a smaller bandwidth than each server interworked therewith, thereby preventing a problem of the bandwidth of interaction between the terminal and the network smaller than the bandwidth of the service server 40.

When a service request message containing a service type is received from each of terminals 10-1, 10-2 and 10-3, the network manager 52 identifies a network which has a larger bandwidth than the service type and the corresponding terminal 10-1, 10-2 or 10-3 is capable of accessing, and transmits a service response message containing the identification information of the corresponding network to the corresponding terminal.

For example, when the third terminal 10-3 requests the streaming service while connected to the fourth network, i.e., Zigbee network, the manager server 50 looks up networks which have a larger bandwidth than 19 Mbps, which is the minimum bandwidth of the streaming server, and is accessible by the third terminal 10-3, in the first table for the third terminal 10-3.

The manager server 50 then transmits to the third terminal 10-3 the service response message containing the identification information of the second network WLAN or the third network UWB.

That is, the manager server 50 transmits the service response message for the terminal 10-3 to access a network which has a larger bandwidth than the service type requested by the terminal 10-3, which in this case includes the second network WLAN and the third network UWB. The third terminal 10-3 then accesses the second or third network to have access to the streaming server 43.

The resource manager 54 of the network manager 52 identifies the terminal which can change the access network to another network among the terminals 10-1, 10-2 and 10-3 accessing the access network when the resource occupancy of the access network exceeds the maximum efficiency rate which is previously set, and transmits to the identified terminal 10-1, 10-2 or 10-3 an network change request message requesting the identified terminal to change the access network to another network. The resource monitor 2n monitors the resource occupancy of each network and transmits a resource overuse message to the manager server 50 when the resource occupancy exceeds the previously set occupancy (maximum efficiency rate). That is, the resource monitor 2n transmits to the manager server 50 the resource overuse message containing the identification information of the corresponding access network and the IP address information of the terminal 10-1, 10-2 or 10-3 which has access to the corresponding access network when it finds that the occupancy of the corresponding access network exceeds the maximum efficiency rate (e.g., 80%) while monitoring the resource occupancy of the corresponding access network.

When the resource overuse message is received, the resource manager 54 of the manager server 50 identifies the terminal 10-1, 10-2 or 10-3 which can change the access network to another network among the terminals 10-1, 10-2 and 10-3 having access to the corresponding access network and transmits to the corresponding terminal 10-1, 10-2 or 10-3 a network change request message requesting to change the access network to another network.

For example, when the second and third terminals 10-2 and 10-3 access the second network WLAN so that the resource occupancy exceeds the previously set maximum efficiency rate of the second network WLAN, the resource manager 54 identifies the terminal which can change the access network to another network in each first table. That is, the resource manager 54 identifies the terminal which is capable of accessing a plurality of networks.

The resource manager 54 transmits the network change request message to the third terminal 10-3, which is capable of accessing a plurality of networks, and the third terminal 10-3 changes the access network from the second network to the third or fourth network.

The resource manager 54 can determine a new access network according to a type of service with which the third terminal 10-3 is currently provided. For example, when the third terminal 10-3 is currently provided with the camera service, the resource manager 54 determines the third network which has a larger bandwidth than the camera service (5 Mbps), as a new access network and so transmits the network change request message containing the identification information of the third network.

When the network change request message is received from the manager server 50, each terminal 10-1, 10-2 and 10-3 can determine the access network according to a type of a currently provided service. That is, each terminal 10-1, 10-2 and 10-3 recognizes the bandwidth information of each network connected by using the first table, as shown in Table 1, and changes the access network to the network having a larger bandwidth than the currently provided service type.

FIG. 3 is a block diagram of a terminal according to an exemplary embodiment of the present invention.

Each terminal 10-1, 10-2 and 10-3 includes an interface 14 which is capable of accessing at least one network and provides a user with a service provided from the service server 40 through each network.

Referring to FIG. 3, the terminal 10 of the present invention includes at least one interface 14, a memory 11, and a controller 12. The controller 12 includes an interface processor 13.

Each interface 14 provides access to the service server 40 through the established network. That is, each interface 14 provides an interfacing function to access the service server 40 through the network such as the wire LAN, the WLAN, the UWB, and the Zigbee network.

The controller 12 registers the address information allocated through the negotiation procedure with the manager server 50 using a protocol of a network initially accessed by each interface 14. Here, the inherent IP address information is allocated from each network as the address information.

The memory 11 stores operating program information of each terminal 10 and the IP address information allocated from each network.

The interface processor 13 of the controller 12 transmits the service request message containing the service type information selected by a user to the manager server 50 through the initial access network, and changes the access network to the network corresponding to the network identification information contained in the service response message.

More specifically, the interface processor 13 stores the first table containing the bandwidth information of a service provided by the service server 40 received from the manager server 50 in the memory 11, and transmits the service request message containing the service type information selected by the user to the manager server 50.

The interface processor 13 accesses the service server 40 through the interface 14 interworked with the network corresponding to the network identification information contained in the service response message.

That is, the interface processor 13 accesses a multiple network through the interface interworked with the network corresponding to the network identification information received from the manager server 50 while accessing the multiple network through the initially established interface 14.

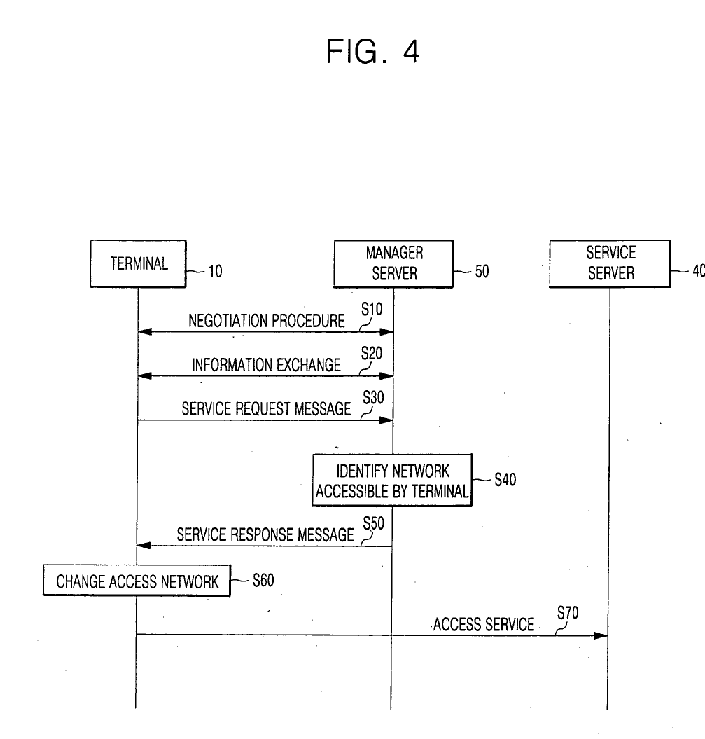

FIG. 4 is a flowchart illustrating a service providing procedure in a multiple network system according to an exemplary embodiment of the present invention.

Referring to FIG. 4, each terminal 10 accesses the initially established network to register with the manager server 50 through the negotiation procedure with the manager server 50 at the initial operating stage (S10). Each terminal 10 registers with the manager server 50 through each network when it is capable of accessing at least one network.

Here, each terminal l0 performs the negotiation procedure according to an IEEE 80.11 protocol when the access network is the second network (WLAN), an IEEE 802.15.3 protocol when the access network is the third network (UWB), and an IEEE 802.15.4 protocol when the access network is the fourth network (Zigbee).

The manager server 50 produces a plurality of first tables which contain the identification information of the network accessed by each terminal 10, the IP address information allocated from the corresponding network, and the network status information (bandwidth information, power, service distance, etc.), as shown in Table 1, through the negotiation procedure with each terminal 10.

The manager server 50 also manages the third table which contains the identification information, the IP address information and status information of each network, as shown in Table 3, and the minimum bandwidth information of each service provided by the service server 40, as shown in Table 2.

The manager server 50 transmits a corresponding first table to each terminal 10. Each terminal 10 and the manager server 50 exchange status information and IP address information of the network (S20).

Each terminal 10 transmits the service request message containing the service type information selected by the user to the manager server 50 (S30).

In response, the manager server 50 identifies a network to be accessed by the corresponding terminal according to the service type information contained in the service request message (S40).

That is, the manager server 50 identifies a network which has a larger bandwidth than the minimum bandwidth of the service type requested by the corresponding terminal 10.

For example, when the terminal 10 transmits to the manager server 50 the service request message requesting the streaming service in a state in which it is capable of accessing the third network (UWB) and the fourth network (Zigbee) and currently has access to the fourth network, the manager server 50 identifies a network which has a larger bandwidth than the minimum bandwidth of the streaming service.

Then, the manager server 50 transmits the service response message containing the identification information of the third network to the corresponding terminal 10 since the third network UWB has a larger bandwidth than 19 Mbps, which is the minimum bandwidth of the streaming service (S50).

Here, when two or more networks accessible by each terminal 10 are identified, the manager server 50 selects the network which has the smallest resource occupancy and transmits the service response message containing the identification information of the corresponding network to the corresponding terminal 10.

The terminal 10 changes the access network according to the network identification information contained in the service response message (S60).

Then, the terminal 10 accesses the service server 40 which provides the service selected by the user through the new access network (S70).

Accordingly, the terminal 10 is capable of accessing the service server 40 through the optimum access network most suitable for the service type selected by the user.

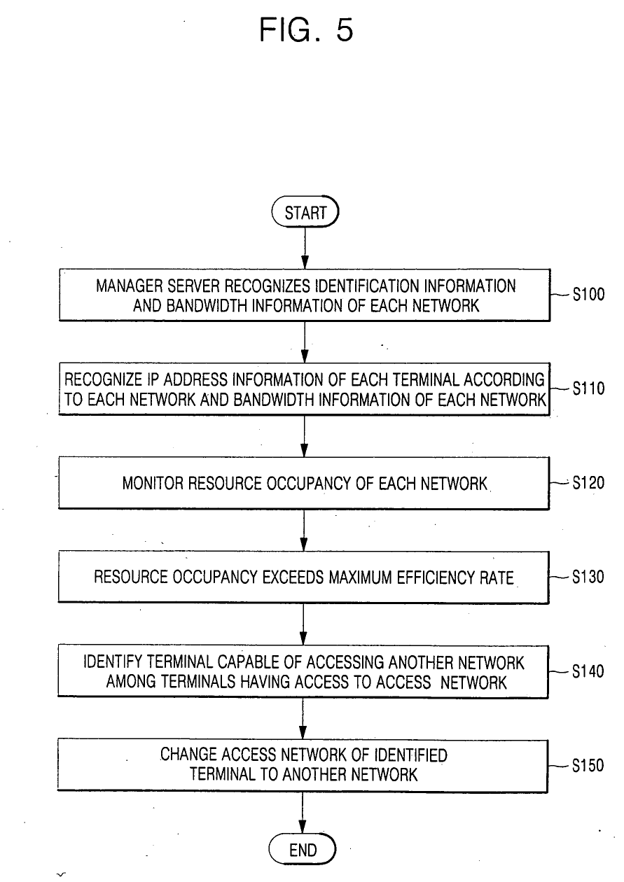

FIG. 5 is a flowchart illustrating a resource managing method in a multiple network system according to an exemplary embodiment of the present invention.

Referring to FIG. 5, the manager server 50 recognizes the status information (bandwidth information) of each network and the identification information (IP address information) of each network (S 100). Here, the manager server 50 recognizes the IP address information and the status information of each network in the form of a table as shown in Table 2.

Also, the manager server 50 recognizes the IP address information according to each network and the status information of each network through the negotiation procedure with each terminal 10 which has access through a multiple network (S110).

Each resource monitor 2n monitors the resource occupancy of each network (S120), and transmits to the manager server 50 the resource overuse message containing the network identification information and the IP address of the corresponding terminal 10 when the resource occupancy of the corresponding network exceeds the previously set maximum efficiency rate (S130).

The manager server 50 receives the resource overuse message and identifies a terminal 10 which can change to another network among the terminals 10 accessing the corresponding network (S140).

For example, when the first and second terminals 10-1 and 10-2 access the second network (WLAN) so that the resource occupancy of the second network exceeds the maximum efficiency rate, the manager server 50 selects the first terminal 10-1 as the terminal 10 which can change its access network to another network (i.e., first network wire LAN).

The manager server 50 then transmits the network change request message containing the identification information of the first network to the first terminal 10.

In response, the first terminal 10-1 changes the access network to the first network according to the network identification information contained the network change request message (S150).

Subsequently, the first terminal 10-1 accesses the service server 40 through the first network.

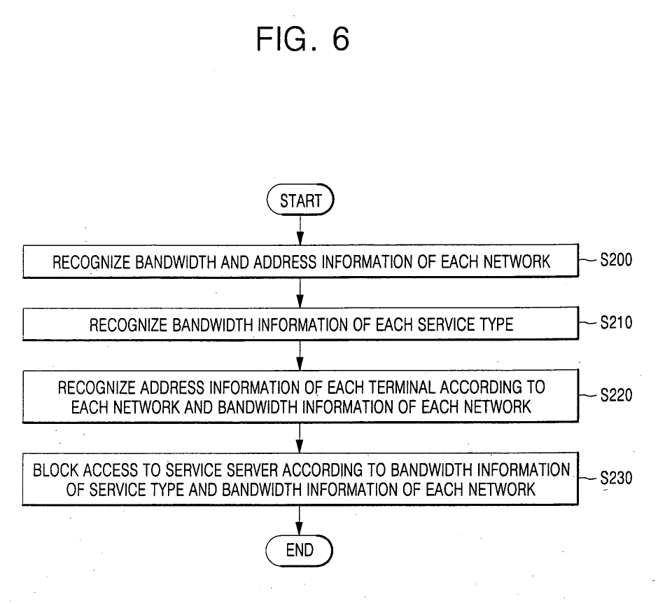

FIG. 6 is a flowchart illustrating a network managing method in a multiple network system according to an exemplary embodiment of the present invention.

Referring to FIG. 6, the manager server 50 recognizes the status information (bandwidth information) and the IP address information of each network in the multiple network (S200). The manager server 50 recognizes the status information and the IP address information of each network, as shown in Table 3.

Also, the manager server 50 recognizes the minimum bandwidth information of a service provided by the service server 40 (S210). That is, the manager server 50 recognizes the bandwidth information of each service provided by the service server 40 as shown in Table 2.

Moreover, the manager server 50 recognizes the status information and the IP address information of each network through the negotiation procedure with each terminal 10 which has accesses through the multiple network (S220). In addition, the manager server 50 manages a plurality of first tables containing the status information and the IP address information of each network accessed by each terminal 10 as shown in Table 1 and transmits a corresponding first table to each terminal 10.

The manager server 50 transmits the blocking message containing the bandwidth information of each network and the IP address information whose access to the service server 40 is to be blocked according to the bandwidth information of the network accessed by each terminal 10, to each filter 3n interworked with the service server 40.

That is, the manager server 50 transmits the blocking message containing the IP address information of networks having a smaller bandwidth than the minimum bandwidth of the service server 40 and the IP address information of the terminal 10 which accesses the corresponding network to each filter 3n interworked with the service server 40.

As a result, each filter 3n blocks access of the network and the terminal 10 which have the IP address information contained in the blocking message (S230).

That is, each filter 3n blocks access of the terminal 10 to networks having a smaller bandwidth than the minimum bandwidth of the service provided by the service server 40, thereby preventing problems caused by the bandwidth of the network being smaller than the bandwidth of the service.

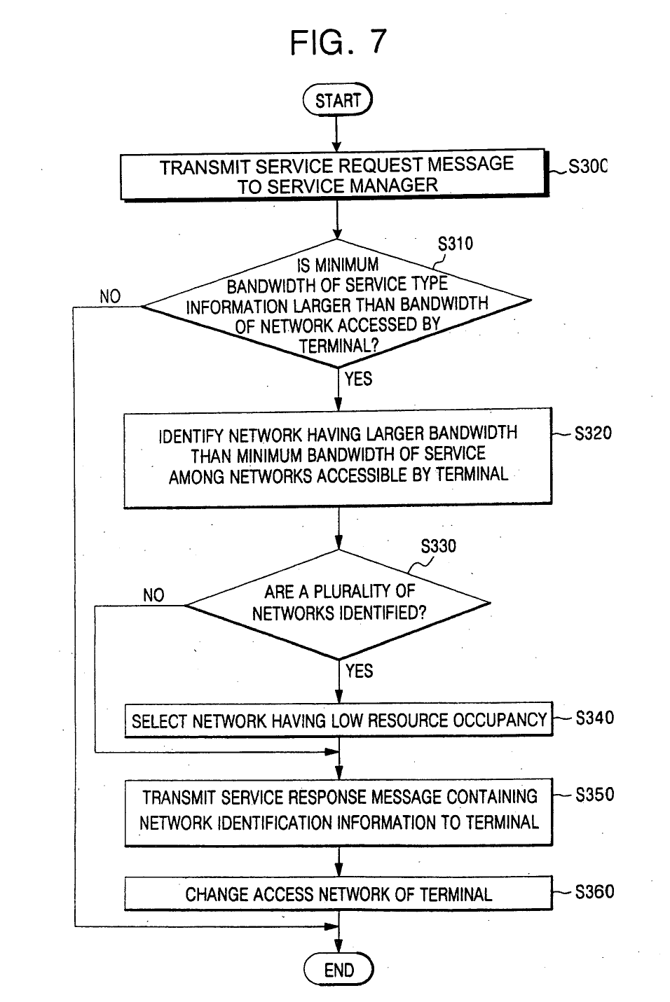

FIG. 7 is a flowchart illustrating a service providing method in a multiple network system according to an exemplary embodiment of the present invention.

Referring to FIG. 7, each terminal 10 transmits the service request message containing the service type information selected by the user to the manager server 50 (S300).

The manager server 50 compares the minimum bandwidth information of the service type contained in the service request message to the bandwidth information of the network accessed by the terminal 10 (S310).

Here, the manager server 50 recognizes the bandwidth information, the identification information and the IP address information of each network, the IP address information of each terminal 10 allocated from each network, and the bandwidth information of each service type provided by the service server 40.

Thus, the manager server 50 identifies a network that has a greater bandwidth than the minimum bandwidth of the service among the networks which are accessible by the terminal 10 when the access network currently accessed by the corresponding terminal 10 has a smaller bandwidth than the minimum bandwidth of the corresponding service (S320).

For example, when the third terminal 10-3 transmits the service request message requesting streaming service (minimum bandwidth 19 Mbps) to the manager server 50 in a state in which the third terminal 10-3 is capable of accessing the second network (WLAN), the third network (UWB), and the fourth network (Zigbee) and is currently accessing the fourth network, the manager server 50 compares the minimum bandwidth information (19 Mbps) of the streaming service to the bandwidth information (250 Kbps) of the fourth network.

Since the bandwidth information of the fourth network currently accessed by the terminal 10 is smaller than the minimum bandwidth information of the streaming service, the manager server 50 investigates the second and third networks.

When a plurality of networks are selected (S330), the manager server 50 selects the network which has the lowest resource occupancy among the plurality of networks (S340) and transmits the service response message containing the identification information of that network to the corresponding terminal 10 (S350).

The terminal 10 then changes the access network according to the identification information contained in the service response message to access the service server 40 which provides the service selected by the user (S360).

In the above described exemplary embodiments, the multiple network system includes the wireless line LAN, the WLAN, the UWB, and the Zigbee network, and can further include other wired or wireless networks.

Also, in the above described exemplary embodiments, the terminal changes the access network according to the bandwidth of the service and the bandwidth of the network, but other status information (e.g., power) can be used for the terminal to change the access network.

As described above, the present invention can prevent problems caused by the bandwidth of each network and the bandwidth of the terminal being smaller than the bandwidth of the service.

With the present invention, it is possible to efficiently manage resources of each network in a multiple network.

While the present invention has been described with reference to exemplary embodiments thereof, it will be understood by those skilled in the art that various changes in form and detail may be made therein without departing from the scope of the present invention as defined by the following claims

What is claimed is:

1. A multiple network system, comprising:
a service server for providing at least one service;
at least one terminal for accessing at least one network; and
a manager server for recognizing a bandwidth of each service provided by the service server, a permissible bandwidth of each network, and each terminal accessing each network, and, for each service, blocking access of each terminal requesting the service to each network having a smaller permissible bandwidth than the service.

2. The system of claim 1, wherein the manager server recognizes address information of the network and address information of each terminal accessing each network, according to the network, and, for each service, blocks access between the address information of each terminal requesting the service and the address information of each network having a smaller permissible bandwidth than the service.

3. The system of claim 1, further comprising: at least one blocking filter for blocking access of the network or terminal according to address information contained in access blocking information received from the manager server.

4. The system of claim 1, wherein the manager server comprises:
an information recognizing unit for recognizing bandwidth information of each service, permissible bandwidth information and address information of each network, and address information of each terminal according to network; and
a network setting unit for setting in the blocking filter, for each service, address information of a network having a smaller permissible bandwidth than the service and address information of a terminal accessing the network.

5. The system of claim 1, wherein each network is at least one of a wired local area network (wire LAN), a wireless LAN (local area network), an ultra wide band (UWB) network, and a Zigbee network.

6. The system of claim 1, further comprising: at least one monitoring unit for monitoring a resource occupancy of each network and transmitting to the manager server identification information of a corresponding network and address information of a terminal which accesses the corresponding network when the resource occupancy exceeds a previously set reference occupancy.

7. The system of claim 1, wherein the manager server identifies a terminal which is capable of accessing another network and transmits a network change request message when the identification information of the network and the address information of the terminal are received from the monitoring unit.

8. The system of claim 7, wherein the manager server transmits the network change request message containing identification information of a network having a relatively large permissible bandwidth when the number of networks accessible by the identified terminal is at least one.

9. The system of claim 1, wherein each terminal transmits a service request message containing a service type selected by a user to the manager server.

10. The system of claim 1, wherein the manager server transmits to the terminal a service response message containing identification information of a network which has a larger bandwidth than the service type among networks accessible by the terminal when the bandwidth of the service type contained in the service request message is smaller than the permissible bandwidth of the network accessed by the terminal.

11. The system of claim 1, wherein each terminal comprises:
at least one interface for accessing each network; and
an interface processor for transmitting the service request message to the manager server through the at least one interface and accessing the service server through the interface interworked with a network corresponding to the network identification information contained in the service response message.

12. A multiple network system accessed by at least one terminal, comprising:
a manager server for identifying a terminal which is enabled to access another network among terminals accessing an access network and transmitting a network change request message to the terminal when a resource occupancy of each network exceeds a reference resource occupancy,
wherein the terminal changes the access network to another network accessible thereby when the network change request message is received from the manager server.

13. The system of claim 12, further comprising: at least one monitoring unit for monitoring a resource occupancy of each network and transmitting identification information of a corresponding network and address information of a terminal which accesses the corresponding network when the resource occupancy exceeds a previously set reference occupancy.

14. The system of claim 12, wherein the manager server recognizes identification information of a network and identification information of a network accessible by the terminal and transmits the network change request message containing identification information of a network having a large permissible bandwidth among networks accessible by the terminal accessing the corresponding access network when a resource occupancy of the network exceeds a reference resource occupancy.

15. A multiple network system including at least one terminal and a service server, comprising:
a manager server for recognizing bandwidth information of each service provided by the service server, permissible bandwidth information of each network, or identification information of a network accessible by each terminal, and transmitting to a corresponding terminal identification information of a network having a larger bandwidth than a service requested by the terminal, among the networks accessible by the terminal, when the bandwidth of the service is larger than a permissible bandwidth of the network accessed by the terminal,
wherein the service requested by the terminal is selected by a user and requested to the manager server, and the terminal accesses the service server through a network corresponding to the identification information.

16. A service providing method in a multiple network system accessed by at least one terminal, comprising:
recognizing bandwidth information of at least one service, permissible bandwidth information of each network, address information of each network, or address information of each terminal accessing each network;
receiving a service request from each terminal; and
blocking access to the service when a bandwidth of the service requested by the terminal is larger than the permissible bandwidth of the network currently accessed by the terminal.

17. The method of claim 16, wherein in the step of recognizing, address information of at least one network accessible by each terminal is recognized.

18. The method of claim 16, further comprising:
recognizing identification information of each network;
recognizing address information of a terminal accessing an access network when a resource occupancy of the access network exceeds a previously set reference occupancy;
identifying a terminal capable of accessing another network and transmitting identification information of the other network to the identified terminal; and
changing the access network accessed by the terminal to a network corresponding to the transmitted network identification information.

19. The method of claim 16, further comprising:
at each terminal, requesting a service type selected by a user;
identifying a network accessible by the terminal when a permissible bandwidth of the network currently accessed by the terminal is smaller than a bandwidth of the requested service; and
transmitting identification information of the identified network to the terminal and changing the access network accessed by the terminal to identified network, thereby enabling the service to be used.

20. A service providing method in a multiple network system accessed by at least one terminal, comprising:
recognizing identification information of each network and address information of each terminal capable of accessing each network;
recognizing address information of a terminal accessing a network when a resource occupancy of the network exceeds a previously set reference occupancy;
identifying a terminal capable of accessing another network and transmitting identification information of the other network to the identified terminal; and
changing the network accessed by the terminal to the other network corresponding to the identification information.

21. The method of claim 20, further comprising:
recognizing permissible bandwidth information of each network and bandwidth information of each service; and
selecting identification information of a network having a large permissible bandwidth among networks accessible by the identified terminal.

22. A service providing method in a multiple network system accessed by at least one terminal, comprising:
recognizing bandwidth information of at least one service, permissible bandwidth information of each network, or identification information accessible by each terminal;
requesting, at each terminal, a service type selected by a user;
identifying a network accessible by a terminal when a permissible bandwidth of a network currently accessed by the terminal is smaller than a bandwidth of the requested service; and
transmitting identification information of the identified network to the terminal so that the terminal is provided with the service through the identified network.

23. The method of claim 22, further comprising:
transmitting identification information of each identified network to the terminal when a plurality of networks are identified; and
using a service through a network having relatively large permissible bandwidth information among the identified networks.

24. The method of claim 22, further comprising:
managing a resource occupancy of each network; and
transmitting identification information of an identified network having a relatively small resource occupancy to the corresponding terminal when a plurality of networks are identified.
